(19) United States
(12) Patent Application Publication
(10) Pub. No.: US 2023/0375345 A1
(43) Pub. Date: Nov. 23, 2023

(54) METHOD AND SYSTEM FOR VEHICLE ROUTE OPTIMIZATION

(71) Applicant: Tata Consultancy Services Limited, Mumbai (IN)

(72) Inventors: VISWANATH KUMAR GANESAN, Chennai (IN); HARIPRIYA KRISHNADAS, Chennai (IN)

(73) Assignee: Tata Consultancy Services Limited, Mumbai (IN)

(21) Appl. No.: 18/185,451

(22) Filed: Mar. 17, 2023

(30) Foreign Application Priority Data
May 17, 2022 (IN) 202221028386

(51) Int. Cl. G01C 21/34; G06Q 10/0835

(52) U.S. Cl. CPC G01C 21/3407; G06Q 10/08355

(57) ABSTRACT

State of the art vehicle route optimization approaches fail to handle growing customer needs. The disclosure herein generally relates to route planning, and, more particularly, to a method and system for vehicle route optimization. The system obtains information on (i) a network of customers, wherein the network of customers comprises nodes corresponding to a plurality of customer locations and a depot, and edges representing connections between the customer locations, (ii) distance between each pair of customer locations among the plurality of customer locations, (iii) one or more orders received from one or more of the customers, (iv) service start time, (v) service end time, and (vi) servicing time, as input data, and then by processing the input data, performs vehicle route optimization at different levels, till an optimized route plan is obtained.

### PRIORITY CLAIM

This U.S. patent application claims priority under 35 U.S.C. § 119 to: Indian Patent Application No. 202221028386, filed on May 17, 2022. The entire contents of the aforementioned application are incorporated herein by reference.

### TECHNICAL FIELD

The disclosure herein generally relates to route planning, and, more particularly, to a method and system for vehicle route optimization.

### BACKGROUND

Vehicle routing problems (VRP) have been widely studied as combinatorial optimization problems for decades and the need to solve larger sized problems for many practical applications in transportation and logistics have been growing manifold. The expectations to deliver goods to customers with minimized logistics cost and on promised timelines has become an area of interest in recent years with many e-commerce and logistics players bringing in varied capabilities. Many practical applications in delivery logistics share a common problem definition viz., vehicles starting from a common location called depot, visiting multiple customer locations or destinations to deliver goods or services with delivery windows, customer priorities, etc., and finally all of them returning back to the depot while ensuring that each and every customer is serviced once and/or multiple times. When a capacity is imposed on each vehicle it forms a Capacitated VRP (CVRP). A number of variations in VRP are found depending on the requirements on pickup or drop off needs and commitments on delivery such as time windows, on time delivery, etc. Most of the VRPs are classified as NP Hard problem. In certain situations, as it is difficult to optimize a NP Hard problem within a reasonable time limit, soft constraints on violations with respect to delivery requirements on delivery windows, priorities and other related factors at delivery locations are introduced which is defined as the VRP with soft time windows.

Many of the existing approaches have solved the VRP problem with or without time windows using different algorithms and tested with different benchmarks. However, limitation of the existing approaches is that they have not been able to address growing customer demands as well as business requirements to service millions of customers in a larger geography in a planning period with a scalable application hardware and system configurations dynamically in a completely novel automated way that saves good amount of manual effort, and other practical costs.

### SUMMARY

Embodiments of the present disclosure present technological improvements as solutions to one or more of the above-mentioned technical problems recognized by the inventors in conventional systems. For example, in one embodiment, a processor implemented method for vehicle route optimization is provided. The method involves initially obtaining, via one or more hardware processors, information on (i) a network of customers, wherein the network of customers comprises nodes corresponding to a plurality of customer locations and a depot, and edges representing connections between the customer locations, (ii) distance between each pair of customer locations among the plurality of customer locations, (iii) one or more orders received from one or more of the customers, (iv) service start time, (v) service end time, and (vi) servicing time. Further, a plurality of initial routes are created based on the network of customers, by considering the depot as a center coordinate and by calculating polar angles of the nodes in the network of customers, to assign the nodes to the routes. Further, the plurality of initial routes are divided into a plurality of segments wherein each of the plurality of segments comprises a set of adjacent routes from among the plurality of initial routes. Further, an optimal set of routes corresponding to the plurality of initial routes is obtained. Obtaining the optimal set of routes involves the following steps. Initially, an order matrix is created for the one or more orders wherein the order matrix indicates each of the one or more orders as being serviceable or non-serviceable. Further, a first set of routes is obtained from the plurality of initial routes, based on data in the order matrix, wherein in the first set of routes, the routes are grouped based on proximity to form a plurality of pairs of routes. Further, a second set of routes is generated, wherein the second set of routes is generated by swapping orders between different pairs of routes in the first set of routes. Further, an order from one route is inserted to another route in each pair of routes in the second set of routes, followed by updating the segment by including a pre-defined percentage of routes existing in the segment and by taking a pre-defined percentage of routes from remaining segments.

In another aspect, obtaining the first set of routes comprises the following steps. Initially a quadrilateral corresponding to each route among set of routes within the segment is determined, wherein the quadrilateral has (i) minimum latitude, (ii) minimum longitude, (iii) maximum latitude, and (iv) maximum longitude, as four corner points, identified based on geocoordinates of nodes in the route. Further, geocoordinates of the node in a first route in the set of routes are fetched. Further, a second route is identified such that geocoordinates of the node in the first route lies within the quadrilateral corresponding to the second route. Further, the node in the first route is exchanged with a node in the second route. Further, a third route is identified and the node in the second route is inserted into a minimum distance position of the third route. Further, it is determined if a resultant set of routes with updated first, second, and third routes is feasible based on a calculated total distance for the resultant set of routes. Further, a local optimization is performed on the updated first, second and third routes to obtain the first set of routes, wherein the local optimization comprises swapping of one or more orders between the first, second and third routes such that a pre-defined delivery window constraint is satisfied and total distance travelled in the routes is minimum.

In yet another aspect, a system for vehicle route optimization is provided. The system includes one or more hardware processors, a communication interface, and a memory storing a plurality of instructions. The plurality of instructions when executed, cause the one or more hardware processors to obtain information on (i) a network of customers, wherein the network of customers comprises nodes corresponding to a plurality of customer locations and a depot, and edges representing connections between the customer locations, (ii) distance between each pair of customer locations among the plurality of customer locations, (iii) one or more orders received from one or more of the customers, (iv) service start time, (v) service end time, and (vi) servicing time. Further, a plurality of initial routes are created based on the network of customers, by considering the depot as a center coordinate and by calculating polar angles of the nodes in the network of customers, to assign the nodes to the routes. Further, the plurality of initial routes are divided into a plurality of segments wherein each of the plurality of segments comprises a set of adjacent routes from among the plurality of initial routes. Further, an optimal set of routes corresponding to the plurality of initial routes is obtained. Obtaining the optimal set of routes involves the following steps. Initially, an order matrix is created for the one or more orders wherein the order matrix indicates each of the one or more orders as being serviceable or non-serviceable. Further, a first set of routes is obtained from the plurality of initial routes, based on data in the order matrix, wherein in the first set of routes, the routes are grouped based on proximity to form a plurality of pairs of routes. Further, a second set of routes is generated, wherein the second set of routes is generated by swapping orders between different pairs of routes in the first set of routes. Further, an order from one route is inserted to another route in each pair of routes in the second set of routes, followed by updating the segment by including a pre-defined percentage of routes existing in the segment and by taking a pre-defined percentage of routes from remaining segments.

In yet another aspect, the system obtains the first set of routes by executing the following steps. Initially a quadrilateral corresponding to each route among set of routes within the segment is determined, wherein the quadrilateral has (i) minimum latitude, (ii) minimum longitude, (iii) maximum latitude, and (iv) maximum longitude, as four corner points, identified based on geocoordinates of nodes in the route. Further, geocoordinates of the node in a first route in the set of routes are fetched. Further, a second route is identified such that geocoordinates of the node in the first route lies within the quadrilateral corresponding to the second route. Further, the node in the first route is exchanged with a node in the second route. Further, a third route is identified and the node in the second route is inserted into a minimum distance position of the third route. Further, it is determined if a resultant set of routes with updated first, second, and third routes is feasible based on a calculated total distance for the resultant set of routes. Further, a local optimization is performed on the updated first, second and third routes to obtain the first set of routes, wherein the local optimization comprises swapping of one or more orders between the first, second and third routes such that a pre-defined delivery window constraint is satisfied and total distance travelled in the routes is minimum.

In yet another aspect, a non-transitory computer readable medium for vehicle route optimization is provided. The non-transitory computer readable medium includes a plurality of instructions, which when executed, cause the one or more hardware processors to perform the following steps. Initially, information on (i) a network of customers, wherein the network of customers comprises nodes corresponding to a plurality of customer locations and a depot, and edges representing connections between the customer locations, (ii) distance between each pair of customer locations among the plurality of customer locations, (iii) one or more orders received from one or more of the customers, (iv) service start time, (v) service end time, and (vi) servicing time, are obtained. Further, a plurality of initial routes are created based on the network of customers, by considering the depot as a center coordinate and by calculating polar angles of the nodes in the network of customers, to assign the nodes to the routes. Further, the plurality of initial routes are divided into a plurality of segments wherein each of the plurality of segments comprises a set of adjacent routes from among the plurality of initial routes. Further, an optimal set of routes corresponding to the plurality of initial routes is obtained. Obtaining the optimal set of routes involves the following steps. Initially, an order matrix is created for the one or more orders wherein the order matrix indicates each of the one or more orders as being serviceable or non-serviceable. Further, a first set of routes is obtained from the plurality of initial routes, based on data in the order matrix, wherein in the first set of routes, the routes are grouped based on proximity to form a plurality of pairs of routes. Further, a second set of routes is generated, wherein the second set of routes is generated by swapping orders between different pairs of routes in the first set of routes. Further, an order from one route is inserted to another route in each pair of routes in the second set of routes, followed by updating the segment by including a pre-defined percentage of routes existing in the segment and by taking a pre-defined percentage of routes from remaining segments.

In yet another aspect, the non-transitory computer readable medium obtains the first set of routes comprising the following steps. Initially a quadrilateral corresponding to each route among set of routes within the segment is determined, wherein the quadrilateral has (i) minimum latitude, (ii) minimum longitude, (iii) maximum latitude, and (iv) maximum longitude, as four corner points, identified based on geocoordinates of nodes in the route. Further, geocoordinates of the node in a first route in the set of routes are fetched. Further, a second route is identified such that geocoordinates of the node in the first route lies within the quadrilateral corresponding to the second route. Further, the node in the first route is exchanged with a node in the second route. Further, a third route is identified and the node in the second route is inserted into a minimum distance position of the third route. Further, it is determined if a resultant set of routes with updated first, second, and third routes is feasible based on a calculated total distance for the resultant set of routes. Further, a local optimization is performed on the updated first, second and third routes to obtain the first set of routes, wherein the local optimization comprises swapping of one or more orders between the first, second and third routes such that a pre-defined delivery window constraint is satisfied and total distance travelled in the routes is minimum.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary system for vehicle route optimization, according to some embodiments of the present disclosure.

FIGS. 2A and 2B (collectively referred to as FIG. 2) is a flow diagram depicting steps involved in the process of vehicle route optimization by the system of FIG. 1, according to some embodiments of the present disclosure.

FIGS. 3A and 3B (collectively referred to as FIG. 3) is a flow diagram depicting steps involved in the process of obtaining the first set of routes, by the system of FIG. 1, in accordance with some embodiments of the present disclosure.

FIG. 4 is a flow diagram depicting a broad overview of the steps in the vehicle route optimization performed by the system of FIG. 1, in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

Many of the existing approaches have solved the Vehicle Routing Problems (VRP) with or without time windows using different algorithms and tested with different benchmarks. However, limitation of the existing approaches is that they have not been able to address growing customer demands as well as business requirements to service millions of customers in a larger geography in a planning period with a scalable application hardware and system configurations dynamically in a completely in a novel automated way that saves good amount of manual effort, invention and other practical costs. Method and system disclosed herein are related to route planning, and, more particularly, for vehicle route optimization.

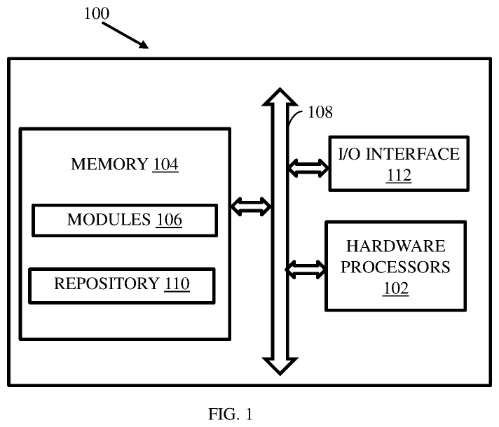

Referring now to the drawings, and more particularly to FIG. 1 through FIG. 4, where similar reference characters denote corresponding features consistently throughout the figures, there are shown preferred embodiments and these embodiments are described in the context of the following exemplary system and/or method.

FIG. 1 illustrates an exemplary system for vehicle route optimization, according to some embodiments of the present disclosure. The system 100 includes or is otherwise in communication with hardware processors 102, at least one memory such as a memory 104, an I/O interface 112. The hardware processors 102, memory 104, and the Input/Output (I/O) interface 112 may be coupled by a system bus such as a system bus 108 or a similar mechanism. In an embodiment, the hardware processors 102 can be one or more hardware processors.

The I/O interface 112 may include a variety of software and hardware interfaces, for example, a web interface, a graphical user interface, and the like. The I/O interface 112 may include a variety of software and hardware interfaces, for example, interfaces for peripheral device(s), such as a keyboard, a mouse, an external memory, a printer and the like. Further, the I/O interface 112 may enable the system 100 to communicate with other devices, such as web servers, and external databases.

The I/O interface 112 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface 112 may include one or more ports for connecting several computing systems with one another or to another server computer. The I/O interface 112 may include one or more ports for connecting several devices to one another or to another server.

The one or more hardware processors 102 may be implemented as one or more microprocessors, microcomputers, microcontrollers, digital signal processors, central processing units, node machines, logic circuitries, and/or any devices that manipulate signals based on operational instructions. Among other capabilities, the one or more hardware processors 102 is configured to fetch and execute computer-readable instructions stored in the memory 104.

The memory 104 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. In an embodiment, the memory 104 includes a plurality of modules 106.

The plurality of modules 106 include programs or coded instructions that supplement applications or functions performed by the system 100 for executing different steps involved in the vehicle route optimization, being performed by the system 100. The plurality of modules 106, amongst other things, can include routines, programs, objects, components, and data structures, which performs particular tasks or implement particular abstract data types. The plurality of modules 106 may also be used as, signal processor(s), node machine(s), logic circuitries, and/or any other device or component that manipulates signals based on operational instructions. Further, the plurality of modules 106 can be used by hardware, by computer-readable instructions executed by the one or more hardware processors 102, or by a combination thereof. The plurality of modules 106 can include various sub-modules (not shown). The plurality of modules 106 may include computer-readable instructions that supplement applications or functions performed by the system 100 for the vehicle route optimization.

The data repository (or repository) 110 may include a plurality of abstracted piece of code for refinement and data that is processed, received, or generated as a result of the execution of the plurality of modules in the module(s) 106.

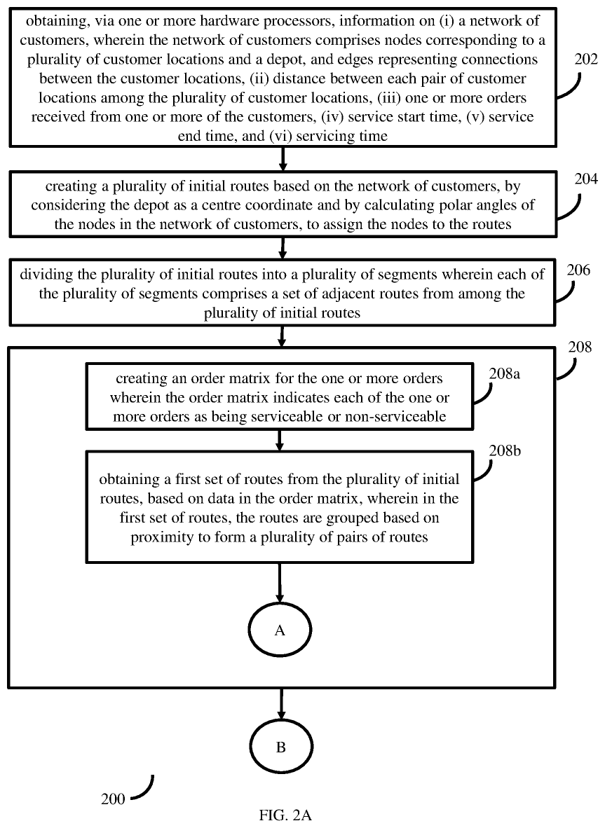

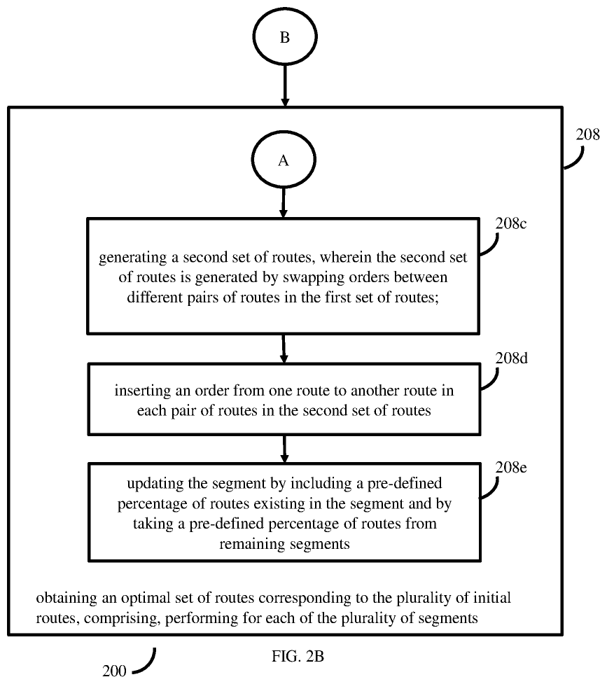

Although the data repository 110 is shown internal to the system 100, it will be noted that, in alternate embodiments, the data repository 110 can also be implemented external to the system 100, where the data repository 110 may be stored within a database (repository 110) communicatively coupled to the system 100. The data contained within such external database may be periodically updated. For example, new data may be added into the database (not shown in FIG. 1) and/or existing data may be modified and/or non-useful data may be deleted from the database. In one example, the data may be stored in an external system, such as a Lightweight Directory Access Protocol (LDAP) directory and a Relational Database Management System (RDBMS). Functions of the components of the system 100 are now explained with reference to steps in flow diagram FIG. 2.

FIGS. 2A and 2B (collectively referred to as FIG. 2) is a flow diagram depicting steps involved in the process of vehicle route optimization by the system of FIG. 1, according to some embodiments of the present disclosure.

A capacitated vehicle routing problem with soft time windows, which is addressed by the system 100 is defined as follows. The problem comprises of a set of identical fleet F of capacity h and a network of customers G(V,E) where V={v₁, v₂, . . . , vₙ, vₙ₊₁} represents set of N customer locations, vₙ₊₁ represents the depot and E represents the edges between them and E=(i,j) where i≠j; i,j>0 and i,j∈V. Each edge (i,j) represents the connectivity between the customer locations i and j. The distance between two customers is denoted as dᵢⱼ. Each order from a customer i may have a demand qᵢ, and if provided as inputs we may also have service start time ssᵢ service end time seᵢ, and a servicing time sᵢ along with customer priorities pᵢ, and other related business parameters as applicable. In case, when an order should be serviced within the given ssᵢ and seᵢ, then a vehicle which has arrived early at the order needs to wait till ssᵢ (Type 1 instance as described in Mouthy et. al). Each customer is defined in a geography using a set of geo-coordinates with values for latitude, latᵢ and longitude, longᵢ.

Assumptions used to define the problem completely are as follows:
A vehicle starts from a depot and each customer is visited only once by any one of the vehicles.
The sum of the demand taken by the vehicle not to exceed its capacity Σqᵢ<=h.
The servicing time sᵢ, at each customer point should be between the service start time, ssᵢ and service end time, seᵢ. [ssᵢ<sᵢ<sₑᵢ], or as applicable with and without delivery windows.
A vehicle arriving early should wait till ssᵢ to start its service or as applicable.
The vehicle departs immediately from the customer location after servicing the customer i.
An order is considered as violated if it is serviced beyond its service end time, seᵢ.
All the vehicles return to the depot after its service completion.

At step 202 of the method 200, the system 100 obtains, via the one or more hardware processors 104, information on (i) a network of customers, wherein the network of customers comprises nodes corresponding to a plurality of customer locations and a depot, and edges representing connections between the customer locations, (ii) distance between each pair of customer locations among the plurality of customer locations, (iii) one or more orders received from one or more of the customers, (iv) service start time, if provided, (v) service end time, and (vi) servicing time and any other related business parameters as applicable and available, as input data.

Further, at step 204 of the method 200, the system 100 creates a plurality of initial routes based on the network of customers, by considering the depot as a centre coordinate (0,0) and by calculating polar angles of the nodes in the network of customers, to assign the nodes to the routes. The nodes are sorted based upon a minimum angle from the depot. Starting with angle as 0, the routes are created with minimum angle nodes until the capacity constraint is satisfied. Once a route is completed the aforementioned steps are repeated until all the nodes are added to the routes.

After forming the routes, heuristics need to be applied for further optimization of the routes. However, applying the heuristics on routes that are far away from each other adversely affects solution quality. In order to address this, at step 206 of the method 200, the system 100 combines nearby routes. To combine the nearby routes, the system 100 divides the plurality of initial routes into a plurality of segments wherein each of the plurality of segments comprises a set of adjacent routes from among the plurality of initial routes. The routes may be identified as adjacent routes by using a pruning technique, in which the number of neighbors for a chosen node or a partial sequence (consecutive set of nodes or customer locations in a route) for an applicable move is determined by the extreme latitude and longitude coordinates of the route that form a rectangle around the route. A neighbor for a node (or a partial sequence) is selected only if the co-ordinate of the node lies within extreme co-ordinates of the neighbor thus reducing the number of local moves performed.

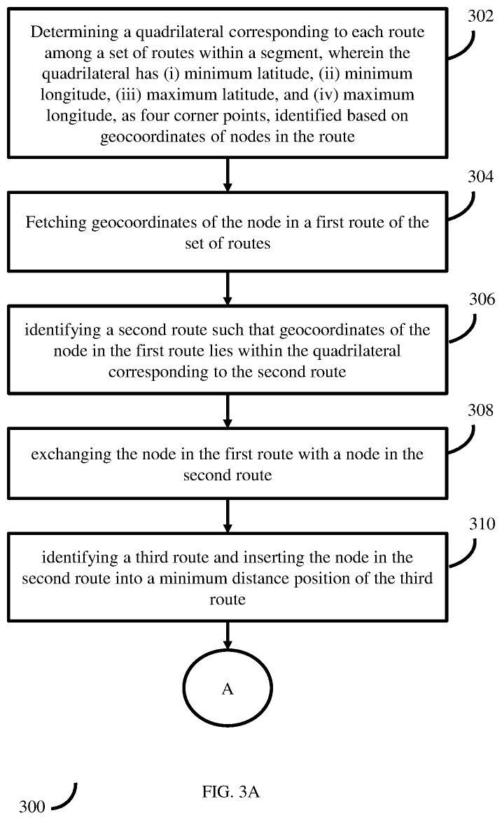

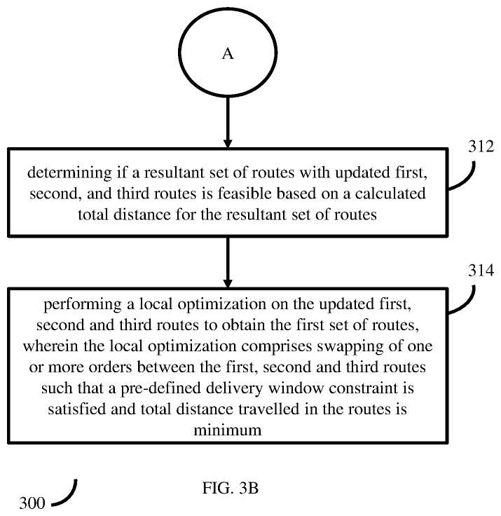

Further, at step 208 of the method 200, the system 100 obtains an optimal set of routes corresponding to the plurality of initial routes. The system 100 obtains the optimal set of routes by performing steps 208a through 208e, for each of the plurality of segments. At step 208a, the system 100 creates an order matrix for the one or more orders wherein the order matrix indicates each of the one or more orders as being serviceable or non-serviceable. An order matrix of size k×k is defined that checks the feasibility between the orders. Elements of the matrix a take value 1 when a vehicle can reach from order i to order j and service order j within the delivery time windows, else takes the value as 0. Further, at step 208b, the system 100 obtains a first set of routes from the plurality of initial routes, based on data in the order matrix, wherein in the first set of routes, the routes are grouped based on proximity to form a plurality of pairs of routes. Various steps involved in the process of obtaining the first set of routes are depicted in method 300 in FIG. 3, and are explained hereafter.

At step 302 of the method 300, the system 100 determines a quadrilateral corresponding to each route among a set of routes within a segment, wherein the quadrilateral has (i) minimum latitude, (ii) minimum longitude, (iii) maximum latitude, and (iv) maximum longitude, as four corner points, identified based on geocoordinates of nodes in the route. At step 304 of the method 300, the system 100 fetches geocoordinates of the node in a first route of the set of routes. In an embodiment, the geocoordinates are fetched from an associated database in which the geocoordinates are stored. In another embodiment, the geocoordinates may be fetched/collected using a geo-positioning system that may be associated with the system 100. Further, at step 306 of the method 300, the system 100 identifies a second route such that geocoordinates of the node in the first route lies within the quadrilateral corresponding to the second route. Further, at step 308 of the method 300, the system 100 exchanges the node in the first route with a node in the second route. Further, at step 310 of the method 300, the system 100 identifies a third route and inserts the node in the second route into a minimum distance position of the third route. A node can be placed in a route at any position. Placing a node at different position would yield different distances. The term “minimum distance position” in this context refers to the fact that the node is placed into another route in a position which yields the minimum distance. The third route also is selected such that geocoordinates of the node in the second route lies within the quadrilateral corresponding to the third route. With the insertion of the nodes, the first node, the second node, and the third node get updated. Further, at step 312 of the method 300, the system 100 determines if a resultant set of routes with updated first, second, and third routes is feasible based on a calculated total distance for the resultant set of routes. To determine if the resultant set of routes is feasible, the system 100 calculates, from an initial solution, the total distance of all the routes. When nodes are moved between routes or any improvement or optimization happens, the system 100 confirms that the total distance of the resultant set of routes have lesser distance than the distance calculated from the initial solution. If the calculated distance for the resultant set of routes at any instance is less, the system 100 replaces the initial solution with the newly obtained resultant set of routes and updates the initial total distance. Further, at step 314 of the method 300, the system 100 performs a local optimization on the updated first, second and third routes to obtain the first set of routes, wherein the local optimization comprises swapping of one or more orders between the first, second and third routes such that a pre-defined delivery window constraint is satisfied and total distance travelled in the routes is minimum. In an embodiment, in addition to or in place of the delivery window constraints, other hard/soft constraints related to deliveries, priorities, and/or any other aspects may be defined and configured. For each node under each sector, the system 100 attempts a swap with other nodes of other routes or same route, provided that the swapping doesn't violate the time window constraints. If the total distance of the new set of routes is lesser than the total set of initial set of routes, the system updates the existing solution with a new solution and also update the total distance. In this context, total distance is the distance travelled by all the routes. The routes obtained with the local optimization form the first set of routes.

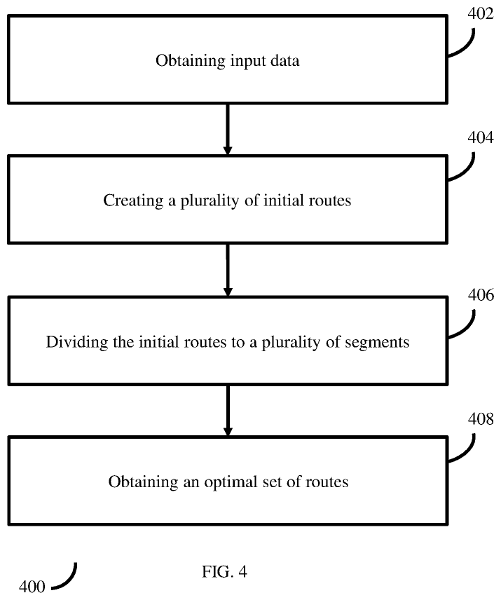

Further, at step 208c, the system 100 generates a second set of routes, wherein the second set of routes is generated by swapping orders between different pairs of routes in the first set of routes. Further, at step 208d, the system 100 inserts an order from one route to another route in each pair of routes in the second set of routes. Further, at step 208e, the system 100 updates the segment by including a pre-defined percentage of routes existing in the segment and by taking a pre-defined percentage of routes from remaining segments. At this stage, the system 100 takes each node of all the routes for insert move, such that the insertion doesn't violate the time violation constraints. If the resultant set of routes have lesser total distance, then the original solution is replaced with new solution. The routes after optimizing the segment form the optimal set of routes, which may be then used for delivery of the orders. A broad overview of the steps involved in the vehicle route optimization are depicted in FIG. 4.

### Experimental Results:

The performance of the method 200 is compared and discussed using the results obtained with the benchmark problems and test data sets in this section. Performance of the method 200 was evaluated against the results presented in Mouthuy et al., on Solomon benchmark instances. Random instances of solomon dataset were considered and applied Type 1 violation as discussed in Mouthy et al.,[10] where vehicle would wait till its service start time. The results have been presented with minimum number of vehicles and distance obtainable for 100% no violation. The results were obtained in less than 10 secs and are presented in Table 1. For the same solomon dataset random instances the violation constraint was relaxed and the results were obtained. In all the cases lesser number of vehicles was obtained. Time taken for all the instances were less than 5 secs which is much lesser than the time taken by Mouthy et al. The results are presented in Table 2. As the focus during the experiments was on large datasets, instances ranging 500 to 10,000 customers were created for parcel distribution in the state of Tamil Nadu, India from a real-life case example and compared the performance of the algorithm against the VLSN. Test instances with 40,000 and 50,000 customer locations in Tamil Nadu geography were also generated to evaluate the method 200 for scalability and performance. The distances between two locations on datasets from Tamil Nadu were computed using Haversine formula. The customer demand qi for the new test instances have been generated using uniform distribution [10,30] and capacity of the vehicle was defined as 200. Delivery start time was defined as the distance from the depot to the delivery location (d) and delivery end time is defined by randomly generating a number from a uniform distribution [1.5d, 2d]. Service time was defined as constant with 10 time units. The VLSN algorithm was not able to scale after 2500 datapoints. A comparison of VLSN with the results obtained with method 200 is given, where 100% no violation was taken as the objective and minimizing vehicles and distance. The results are presented in Table 3. For the instances with 40000 and 50000 different clusters, limit is applied and is presented in Table 4. The method 200 was implemented in Java 7.0 and experiments were run on Windows 10 environment using Intel (R) Core (TM) i5-4570T 2.9 GHz CPU with 8 GB RAM memory.

TABLE 1
Comparing vlsn algorithm with method 200 for R1 Instance
of solomon dataset (Hard Time Constraint)

| VLSN | | | | | Method 200 results | | | |
|---|---|---|---|---|---|---|---|---|
| | Number of | | Orders not | Time | Number of | | Orders not | Time |
| Size | Vehicles | Distance | Violated | (sec) | Vehicles | Distance | Violated | (sec) |
| R101 | 11 | 1214 | 61 | 499 | 30 | 1985 | 100 | 10 |
| R102 | 10 | 1172 | 68 | 523 | 25 | 1779 | 100 | 9 |
| R103 | 9 | 1008 | 76 | 599 | 21 | 1468 | 100 | 8.5 |
| R104 | 9 | 977 | 93 | 624 | 16 | 1253 | 100 | 7 |
| R105 | 10 | 1186 | 69 | 573 | 21 | 1619 | 100 | 7.8 |
| R106 | 10 | 1091 | 81 | 640 | 18 | 1474 | 100 | 8 |
| R107 | 9 | 1013 | 83 | 555 | 14 | 1251 | 100 | 7.7 |
| R108 | 9 | 1004 | 96 | 696 | 13 | 1074 | 100 | 6.5 |
| R109 | 10 | 1132 | 88 | 629 | 16 | 1308 | 100 | 6.6 |
| R110 | 9 | 1010 | 82 | 527 | 17 | 1341 | 100 | 6.8 |
| R111 | 9 | 1016 | 82 | 635 | 16 | 1245 | 100 | 6.9 |
| R112 | 9 | 1000 | 95 | 644 | 12 | 1040 | 100 | 4.7 |

TABLE 2
Comparing vlsn algorithm with method 200 for R1 Instance
of solomon dataset (Soft Time Constraint)

| VLSN | | | | | Method 200 Results | | | |
|---|---|---|---|---|---|---|---|---|
| | Number of | | Orders not | Time | Number of | | Orders not | Time |
| Size | Vehicles | Distance | Violated | (sec) | Vehicles | Distance | Violated | (sec) |
| R101 | 11 | 1214 | 61 | 499 | 8 | 1270 | 40 | 4 |
| R102 | 10 | 1172 | 68 | 523 | 8 | 1155 | 57 | 4.7 |
| R103 | 9 | 1008 | 76 | 599 | 8 | 1162 | 64 | 4.8 |
| R104 | 9 | 977 | 93 | 624 | 8 | 1077 | 81 | 4.6 |
| R105 | 10 | 1186 | 69 | 573 | 8 | 1312 | 58 | 4 |
| R106 | 10 | 1091 | 81 | 640 | 8 | 1120 | 72 | 4.7 |
| R107 | 9 | 1013 | 83 | 555 | 8 | 1096 | 72 | 4 |
| R108 | 9 | 1004 | 96 | 696 | 8 | 1059 | 81 | 4 |
| R109 | 10 | 1132 | 88 | 629 | 8 | 1236 | 60 | 4 |
| R110 | 9 | 1010 | 82 | 527 | 8 | 1233 | 68 | 4.7 |
| R111 | 9 | 1016 | 82 | 635 | 8 | 1074 | 65 | 4.7 |
| R112 | 9 | 1000 | 95 | 644 | 8 | 1088 | 74 | 4.2 |

TABLE 3
Comparison of results with large problem instances from Tamil Nadu state, India.

| VLSN | | | | | Results of method 200 | | | |
|---|---|---|---|---|---|---|---|---|
| | Number of | | Orders not | Time | Number of | | Orders not | Time |
| Size | Vehicles | Distance | Violated | (mins) | Vehicles | Distance | Violated | (mins) |
| 500 | 64 | 6335 | 328 | 3.95 | 77 | 10354 | 500 | 0.25 |
| 1000 | 128 | 12996 | 804 | 35.55 | 135 | 21853 | 1000 | 0.466667 |
| 2500 | 318 | 59442 | 2029 | 1351 | 342 | 80395 | 2500 | 1.166667 |
| 5000 | | | | | 676 | 173189 | 5000 | 2.466667 |
| 7500 | | | | | 1003 | 285556 | 7500 | 4.083333 |
| 10000 | | | | | 1331 | 472744 | 10000 | 5.983333 |

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein address unresolved problem of vehicle route optimization. The embodiment, thus provides a mechanism of optimizing routes by determining possibility of exchanging orders between different routes that are close to each other.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method for vehicle route optimization, comprising:
obtaining, via one or more hardware processors, information on (i) a network of customers, wherein the network of customers comprises nodes corresponding to a plurality of customer locations and a depot, and edges representing connections between the customer locations, (ii) distance between each pair of customer locations among the plurality of customer locations, (iii) one or more orders received from one or more of the customers from the network of customers, (iv) service start time, (v) service end time, and (vi) servicing time;
creating a plurality of initial routes based on the network of customers, by considering the depot as a center coordinate and by calculating polar angles of the nodes in the network of customers, to assign the nodes to the plurality of initial routes;
dividing the plurality of initial routes into a plurality of segments wherein each of the plurality of segments comprises a set of adjacent routes from among the plurality of initial routes; and
obtaining an optimal set of routes corresponding to the plurality of initial routes, by performing for each of the plurality of segments the steps of:
creating an order matrix for the one or more orders wherein the order matrix indicates each of the one or more orders as being serviceable or non-serviceable;
obtaining a first set of routes from the plurality of initial routes, based on data in the order matrix, wherein routes among the first set of routes are grouped based on proximity to form a plurality of pairs of routes;
generating a second set of routes, wherein the second set of routes is generated by swapping orders between different pairs of routes in the first set of routes;
inserting an order from one route to another route in each pair of routes in the second set of routes; and
updating the segment by including a pre-defined percentage of routes existing in the segment and by taking a pre-defined percentage of routes from remaining segments.

2. The method of claim 1, wherein the swapping of the orders is performed only if a resulting route satisfies a pre-defined delivery window constraint and reduces total distance travelled in the routes at least by a pre-defined percentage.

3. The method of claim 1, wherein the insertion of routes is performed only if a resultant route satisfies a delivery window constraint and reduces total distance travelled in the routes at least by a pre-defined percentage.

4. The method of claim 1, wherein obtaining the first set of routes comprises:
determining a quadrilateral corresponding to each route among a set of routes within the segment, wherein the quadrilateral has (i) minimum latitude, (ii) minimum longitude, (iii) maximum latitude, and (iv) maximum longitude, as four corner points, identified based on geocoordinates of nodes in the route;
fetching geocoordinates of the node in a first route in the set of routes;
identifying a second route such that geocoordinates of the node in the first route lies within the quadrilateral corresponding to the second route;
exchanging the node in the first route with a node in the second route;
identifying a third route and inserting the node in the second route into a minimum distance position of the third route;
determining if a resultant set of routes with updated first, second, and third routes is feasible based on a calculated total distance for the resultant set of routes; and
performing a local optimization on the updated first, second and third routes to obtain the first set of routes, wherein the local optimization comprises swapping of one or more orders between the first, second and third routes such that a pre-defined delivery window constraint is satisfied and total distance travelled in the routes is minimum.

5. A system for vehicle route optimization, comprising:
one or more hardware processors;
a communication interface; and
a memory storing a plurality of instructions, wherein the plurality of instructions when executed, cause the one or more hardware processors to:
obtain information on (i) a network of customers, wherein the network of customers comprises nodes corresponding to a plurality of customer locations and a depot, and edges representing connections between the customer locations, (ii) distance between each pair of customer locations among the plurality of customer locations, (iii) one or more orders received from one or more of the customers from the network of customers, (iv) service start time, (v) service end time, and (vi) servicing time;
create a plurality of initial routes based on the network of customers, by considering the depot as a center coordinate and by calculating polar angles of the nodes in the network of customers, to assign the nodes to the plurality of initial routes;
divide the plurality of initial routes into a plurality of segments wherein each of the plurality of segments comprises a set of adjacent routes from among the plurality of initial routes; and
obtain an optimal set of routes corresponding to the plurality of initial routes, by performing for each of the plurality of segments the steps of:
creating an order matrix for the one or more orders wherein the order matrix indicates each of the one or more orders as being serviceable or non-serviceable;
obtaining a first set of routes from the plurality of initial routes, based on data in the order matrix, wherein routes among the first set of routes are grouped based on proximity to form a plurality of pairs of routes;
generating a second set of routes, wherein the second set of routes is generated by swapping orders between different pairs of routes in the first set of routes;
inserting an order from one route to another route in each pair of routes in the second set of routes; and
updating the segment by including a pre-defined percentage of routes existing in the segment and by taking a pre-defined percentage of routes from remaining segments.

6. The system as claimed in claim 5, wherein the one or more hardware processors are configured to perform swapping of the orders only if a resulting route satisfies a pre-defined delivery window constraint and reduces total distance travelled in the routes at least by a pre-defined percentage.

7. The system as claimed in claim 5, wherein the one or more hardware processors are configured to perform the insertion of routes only if a resultant route satisfies a delivery window constraint and reduces total distance travelled in the routes at least by a pre-defined percentage.

8. The system as claimed in claim 5, wherein the one or more hardware processors are configured to obtain the first set of routes by:
determining a quadrilateral corresponding to each route among set of routes within the segment, wherein the quadrilateral has (i) minimum latitude, (ii) minimum longitude, (iii) maximum latitude, and (iv) maximum longitude, as four corner points, identified based on geocoordinates of nodes in the route;
fetching geocoordinates of the node in a first route in the set of routes;
identifying a second route such that geocoordinates of the node in the first route lies within the quadrilateral corresponding to the second route;
exchanging the node in the first route with a node in the second route;
identifying a third route and inserting the node in the second route into a minimum distance position of the third route;
determining if a resultant set of routes with updated first, second, and third routes is feasible based on a calculated total distance for the resultant set of routes; and
performing a local optimization on the updated first, second and third routes to obtain the first set of routes, wherein the local optimization comprises swapping of one or more orders between the first, second and third routes such that a pre-defined delivery window constraint is satisfied and total distance travelled in the routes is minimum.

9. One or more non-transitory machine-readable information storage mediums comprising one or more instructions which when executed by one or more hardware processors cause:
obtaining information on (i) a network of customers, wherein the network of customers comprises nodes corresponding to a plurality of customer locations and a depot, and edges representing connections between the customer locations, (ii) distance between each pair of customer locations among the plurality of customer locations, (iii) one or more orders received from one or more of the customers from the network of customers, (iv) service start time, (v) service end time, and (vi) servicing time;
creating a plurality of initial routes based on the network of customers, by considering the depot as a center coordinate and by calculating polar angles of the nodes in the network of customers, to assign the nodes to the plurality of initial routes;
dividing the plurality of initial routes into a plurality of segments wherein each of the plurality of segments comprises a set of adjacent routes from among the plurality of initial routes; and
obtaining an optimal set of routes corresponding to the plurality of initial routes, by performing for each of the plurality of segments the steps of:
creating an order matrix for the one or more orders wherein the order matrix indicates each of the one or more orders as being serviceable or non-serviceable;
obtaining a first set of routes from the plurality of initial routes, based on data in the order matrix, wherein routes among the first set of routes are grouped based on proximity to form a plurality of pairs of routes;
generating a second set of routes, wherein the second set of routes is generated by swapping orders between different pairs of routes in the first set of routes;
inserting an order from one route to another route in each pair of routes in the second set of routes; and
updating the segment by including a pre-defined percentage of routes existing in the segment and by taking a pre-defined percentage of routes from remaining segments.

10. The one or more non-transitory machine-readable information storage mediums of claim 9, wherein the swapping of the orders is performed only if a resulting route satisfies a pre-defined delivery window constraint and reduces total distance travelled in the routes at least by a pre-defined percentage.

11. The one or more non-transitory machine-readable information storage mediums of claim 9, wherein the insertion of routes is performed only if a resultant route satisfies a delivery window constraint and reduces total distance travelled in the routes at least by a pre-defined percentage.

12. The one or more non-transitory machine-readable information storage mediums of claim 9, wherein obtaining the first set of routes comprises:
determining a quadrilateral corresponding to each route among a set of routes within the segment, wherein the quadrilateral has (i) minimum latitude, (ii) minimum longitude, (iii) maximum latitude, and (iv) maximum longitude, as four corner points, identified based on geocoordinates of nodes in the route;
fetching geocoordinates of the node in a first route in the set of routes;
identifying a second route such that geocoordinates of the node in the first route lies within the quadrilateral corresponding to the second route;
exchanging the node in the first route with a node in the second route;
identifying a third route and inserting the node in the second route into a minimum distance position of the third route;
determining if a resultant set of routes with updated first, second, and third routes is feasible based on a calculated total distance for the resultant set of routes; and
performing a local optimization on the updated first, second and third routes to obtain the first set of routes, wherein the local optimization comprises swapping of one or more orders between the first, second and third routes such that a pre-defined delivery window constraint is satisfied and total distance travelled in the routes is minimum.
